(19) United States
(12) Patent Application Publication
(10) Pub. No.: US 2024/0316747 A1
(43) Pub. Date: Sep. 26, 2024

(54) HANDLING DEVICE

(71) Applicant: MTD PRODUCTS INC., Valley City, OH (US)

(72) Inventors: Stefan SAUER, Saarbrucken (DE); Kai Uwe FINK, Saarbrucken (DE); Patrick Christian SCHMIDT, Saarbrucken (DE); Markus ANDORF, Saarbrucken (DE); Ingo KUBIK, St. Wendel (DE)

(21) Appl. No.: 18/737,154

(22) Filed: Jun. 7, 2024

Related U.S. Application Data
(63) Continuation of application No. PCT/EP2022/084322, filed on Dec. 3, 2022.

(30) Foreign Application Priority Data
Dec. 8, 2021 (DE) 102021132353.3

(51) Int. Cl. B25G 3/18; A01G 3/053

(52) U.S. Cl. CPC B25G 3/18; A01G 3/053

(57) ABSTRACT

A handling device (20), in particular for a processing device, such as a gardening and/or household implement, comprising a gripping portion (30) and an electrical power supply (45) in the form of at least one rechargeable battery, wherein the handling device (20) also has contact means (80), which serve alternately, on the one hand, for the electrical and non-electrical connection of a tool (50) to the handling device (20) and, on the other hand, for charging the electrical power supply, in particular by means of a charger (100), and also to a processing device (10), in particular a gardening and/or household device, equipped with such a handling device (20).

### CROSS-REFERENCE TO RELATED APPLICATIONS

The present application is a continuation of international application PCT/EP2022/084322 filed on Dec. 3, 2022, which claims priority under 35 U.S.C. § 119 to German Application Serial No. 102021132353.3 filed on Dec. 8, 2021, which is herein incorporated by reference in its entirety.

### BACKGROUND OF THE INVENTION

### Field of the Invention

The invention relates to a handling device, and to a processing device, in particular a gardening and/or household device, comprising such a handling device.

### Background of the Invention

Handling devices, in particular for processing implements or devices, such as gardening and/or household implements or devices, have been known for some time. Different electrical tools can be connected to such handling devices known from the prior art and either have their own power supply or draw their electrical energy from the handing device.

In addition, handling devices which have a tool that is fixedly connected to the handling device and that is not exchangeable are known from the prior art, the handling device representing the handle, so to speak, of the tool. A power supply for such combined handling/tool implements is generally provided by inserting a rechargeable battery, for example an accumulator or a rechargeable battery pack, usually into the handle element.

In the case of the other handling devices mentioned above, to which different tools can be connected, a power supply is usually likewise provided in that the particular handling device contains a rechargeable battery, such as an accumulator or a rechargeable battery pack, which, after being discharged via the particular tool, is either exchanged for another, charged rechargeable battery or another, charged rechargeable battery pack. For this purpose, such a handling device has an insertion compartment together with electrical contacting and locking means for plugging in and fixing the rechargeable battery or the rechargeable battery pack.

Alternatively, such a handling device to which different tools can be connected may also have a fixedly built-in rechargeable battery which is rechargeable via a charging interface, such as a socket for connecting an external power supply, which is mounted in an accessible manner on an outer surface of the handling device.

All of these solutions known so far for providing a handling device that has a power supply for a tool or different tools have the common disadvantage that such handling devices always have to have several interfaces in order to connect the tool on the one hand and to recharge a discharged rechargeable battery on the other hand. Due to the multiple interfaces required for such handling devices, such handling devices are on the one hand relatively complex in design, since in addition to the necessary electrical contacting means for both the tool and a charger, they also require locking devices for securely holding the particular tool in operation and furthermore also a locking device on a particular insertion compartment for a rechargeable battery or a rechargeable battery pack. Thus, not only is the construction of such handling devices complex and expensive, but there is also an increased susceptibility to error and the possibility of incorrect operation due to the multiple interfaces.

The disclosure addresses the problem of providing a handling device which avoids the above-mentioned disadvantages, has a simpler structure compared to the prior art and can be manufactured cost-effectively.

### SUMMARY OF THE INVENTION

In one aspect, there is provided a handling device, in particular for a processing device, such as a garden and/or household device, having a handle portion and an electrical power supply in the form of at least one rechargeable battery, wherein the handling device further has contact means which serve alternately, on the one hand, for the electrical connection of a tool to the handling device and, on the other hand, for charging the electrical power supply, in particular by means of a charger.

The handling device may use an electrical connection, which is present anyway for connecting an electrical tool to the handling device, in order to charge a power supply in the form of a rechargeable battery, for example at least one accumulator, integrated in the handling device via this connection.

For this purpose, the handling device has contact means which can be alternately connected either to the electrical contacts of a reversibly attachable tool or, in the absence of the tool, to the electrical contacts of an external power supply, for example to a charger. A control unit arranged in the handling device can then be used to set whether the tool is controlled, whether discharge of the power supply integrated in the handling device takes place during operation of the tool, or whether the power supply integrated in the handling device is charged.

In an advantageous manner, only one electrical contact means is thus necessary to connect both an electrical tool and an external charger for recharging the power supply integrated in the handling device to the handling device, which reduces both the complexity of the handling device and a possibility of any incorrect operation compared to the prior art and, moreover, contributes to a cost reduction in the manufacture of the handling device.

The contact means may be arranged in a connecting portion of the handling device arranged distally with respect to the handle portion of the handling device, the connecting portion being formed as a socket. In addition to the contact means for electrically connecting the tool or a charger and/or a charging coupling to the handling device, the connecting portion further comprises also means for mechanically connecting the tool or a charger and/or a charging coupling, to which a charger is or can be connected, to the handling device, said means being arranged inside the socket.

In an advantageous manner, both an electrically operable tool and a charger or a charging coupling for charging a power supply of the handling device can thus be connected to the end that is distal with respect to a handle portion of the handling device in a mechanically fixed and at the same time electrically conductive manner.

To establish a stable, firm and play-free mechanical connection, the particular tool or the device used to charge the integrated power supply of the handling device is inserted into the socket of the connecting portion and detachably locked there by means of a quick connection or a click lock, it being possible to release the connection, for example, by pressing a button to release the lock. Following release of the lock, the tool or the device used to charge the rechargeable battery of the handling device can then be removed again from the connecting portion, or from the socket of the connecting portion, and replaced with another device.

A further advantage associated with a handling device is that the charger or charging coupling, because of its ability to form a fixed connection to the handling, can also be used to store the handling device when it is not in use. For this purpose, the charger or charging coupling used can be fixedly mounted on a wall or shelf, for example, and the handling device is then simply plugged into the charger or charging coupling to charge its integrated power supply. After the handling device has been plugged into the charger or charging coupling, the handling device then hangs, lies or stands in a rest position, fixedly connected to the charger or charging coupling, while at the same time the integrated power supply of the handling device is recharged.

In another aspect, there is provided a processing device, in particular a garden and/or household device, which has a handling device according to the above statements, the processing device comprising a handle portion, a connecting portion and also an electrical power supply and a tool which can be detachably connected to the handling device by means of the connecting portion, the connecting portion having means for the mechanical and electrical connection of the tool and, alternatively with a charger or a charging coupling, to the handling device.

According to an embodiment, the processing device comprises a handling device which, in addition to a gripping portion, comprises a connecting portion which in turn comprises means for both mechanical and electrical connection of a tool to the handling device.

The tool can be an electrical or non-electrical tool, the connecting portion having means by which both the electrical and also alternatively the non-electrical tool can be connected to the handling device.

For this purpose, the connecting portion has common, or identically usable means for the mechanical and, as appropriate, electrical connection of the particular electrical or non-electrical tool to the handling device.

In this way, it is possible to connect both non-electrical tools and electrical tools to the same means of the handling device without having to use different handling devices or different handles. In the connecting portion, which serves to connect to a tool or a charger or a charging coupling, there is means which allow a purely mechanical connection of the tool to the handling device, but at the same time, namely whenever this is required, also an electrical connection of the tool to the handling device.

In an advantageous manner, the handling device also has an electrical power supply, for the purpose of supplying power to electrically operating tools, which is used to operate the electrically operating tools connected to the handling device.

The connecting portion may be in the form of a socket, as mentioned above, wherein the means for mechanically and electrically connecting the tool to the handling device are arranged within the socket.

In this case, the socket represents an end portion of the handling device that is distal from the handle portion of the handling device, and a plug-in pin of the tool and also, if applicable, electrical contacts of the tool can be inserted into said end portion and firmly connected to the handling device.

The connecting portion for mechanically connecting the tool or the charger or the charging coupling to the handling device has detachable form-fit and/or frictional engagement means, for example in the form of at least one plug-in and/or clamping and/or screw and/or detent and/or snap-fit connection with a, preferably non-circular, guide in order to insert a plug-in pin of the tool or of the charger or of the charging coupling as well as its electrical contacts into the connecting portion and to detachably lock them there in a locking position, in particular an end position, for example by pressing a button.

The mechanical connection can be embodied as a plug connection and, if appropriate, also as a screw connection, for example as a bayonet connection, which is locked or fixed, as appropriate, by means of a clamping, detent and/or snap-fit mechanism or also a clamping screw or a union sleeve, wherein the plug-in pin is held, for example, in a latching manner in an undercut or by means of a union sleeve or union nut or is retained by means of a clamping screw in any groove or on its surface.

The connecting portion for electrically connecting the tool to the handling device may further comprise at least two, preferably at least three, four or, as required, more electrical contacts, for example in the form of plug sockets and/or contact surfaces, which establish a contact, in particular an electrically conductive contact, with the corresponding contacts, in particular plugs and/or contact surfaces, of the tool or of the charger or of the charging coupling, via which the power supply integrated in the handling device according to the invention can be charged or discharged.

According to an embodiment, the means for mechanically and electrically connecting the tool to the handling device are arranged relative to each other in such a way that, in an end or latching position, i.e. a locking position, of the mechanical connection, an electrical connection of the various plug sockets and/or contact surfaces with the corresponding plugs and/or contact surfaces of the tool assigned to them is ensured.

The processing device thus has numerous advantages over the previously known prior art. Thus, it is possible in a simple manner to connect a wide variety of tools, whether electrical or non-electrical, to one and the same handling device, both in the form of a stable, mechanical, play-free and easily detachable connection by providing a plug connection which is reliably secured in its end position or, more generally locking position, by a detent and/or snap-fit device. By means of this detent and/or snap-fit device, the plug-in pin of the tool inserted into the socket of the connecting portion is securely fixed in the socket, or in the connecting portion in its end position, wherein the tool or the charger or the charging coupling, or its plug-in pin, can only be removed again from the connecting portion if the detent and/or snap-fit device is deliberately detached, for example by pressing a button, and the plug-in pin of the tool is detached again in this way. Furthermore, the fixing of the plug-in pin or another part of the electrical or non-electrical tool inserted into the socket of the connecting portion can be realised by means of a clamping, for example by means of at least one clamping screw or by means of a union sleeve/union nut.

The plug connection may have a guide which may be non-circular, i.e. is formed in such a way that the plug-in pin of the tool or the charger or the charging coupling, which in turn has a shape corresponding to the non-circular guide, is only inserted into the socket of the connecting portion in a manner predefined by the shape of the guide and is locked there in a precisely predefined position, it is reliably ensured that the tool or the charger/charging coupling, on the one hand, is always connected to this handling device with its correct orientation with respect to the handling device and a faulty connection of the tool or the charger or the charging coupling to the handling device is thus excluded.

Furthermore, the plug connection, which can also be referred to as a quick coupling or click connection due to its simple design, allows a very quick connection of a tool to the handling device and also removal of the tool from the handling device and thus a quick tool change.

The electrical contacting of the tool or the charger or the charging coupling with the relevant corresponding electrical contacts in the distally arranged connecting portion of the handling device, i.e. in the socket of the connecting portion, is performed namely in the course of establishing the mechanical connection of the tool to the handling device, the electrical contacting is carried out simultaneously or quasi-simultaneously with the mechanical connection and locking, wherein the mechanical locking of the plug-in pin of the tool or of the charger or of the charging coupling in a position, preferably locking and/or end position, of the plug-in pin simultaneously ensures that the electrical contacting is also ensured and the electrical contacts of the tool/charger are in electrically conductive connection to the electrical contacts of the handling device, i.e. the electrical contacts arranged in the connecting portion of the handling device.

In an advantageous manner, the guide and securing means for producing a stable, secure and play-free mechanical connection between the tool or charger and the handling device is formed in such a way that this guide simultaneously leads to the secure and accurately fitting contacting of the relevant electrical contacts of the tool or the charger or the charging coupling with the corresponding electrical contacts of the handling device and secures this electrical contacting of the tool with the handling device for the duration of the use of the tool or a charging of the power supply integrated in the handling device on the handling device.

For this purpose, the plug-in pin of the tool or of the charger or of the charging coupling is first inserted into the guide of the socket of the connecting portion, wherein, due to the non-circular embodiment of the guide, the plug-in pin is oriented in the socket during the insertion of the plug-in pin into the socket, so that the electrical contacts of the tool or of the charger or of the charging coupling are also brought into an exact position for contacting the contacts of the handling device. In this context, it should be noted that the electrical contacts of the tool or the charger or the charging coupling are arranged in a fixed position with respect to the plug-in pin. The same applies also to the electrical contacts of the handling device, which are arranged in a corresponding fixed position with respect to the guide and the detent and/or snap-fit device for fixing the plug-in pin in its locking position.

When a non-electrical tool is connected to the handling device, only the mechanical plug-in/detent and/or snap-fit connection comes into play, whereas the electrical sockets are not occupied. In this case, it is possible that the electrical plug sockets remain open to the outside; alternatively, however, a non-electrical tool can also comprise a cover plate which covers the electrical plug sockets to the outside. According to a further alternative, it is also conceivable that plastic plugs are inserted into the various electrical plug sockets instead of electrically conductive plugs, thus protecting the plug sockets from contamination and substantially closing them off from the outside.

The electrical connection of the handling device can be used both for the electrical connection of an electrically operated tool and for the connection of a charger for charging the electrical power supply of the handling device. Such charging of the electrical power supply of the handling device via the electrical contacts provided in the connecting portion has the advantage that no further connection options for charging the electrical power supply of the handling device need to be provided on the handling device, this applying both to the handle portion, or a handle of the handling device, and to the connecting portion of the handling device, as well as to any handle extension of the handling device.

According to an embodiment, the handling device comprises, between the handle portion and the connecting portion, an extension means, for example in the form of a tube extension or a shaft, which is in particular telescopic and optionally reversibly detachable from the handle portion and/or the connecting portion.

This allows objects at a greater distance to be processed by means of a processing device embodied in this way. In this way, it is possible, for example, to saw off branches of a tree from a greater distance by means of a sawing tool or to cut them off by means of pruning shears. It is advantageous if the extension means is telescopic, as this allows the length of the processing device to be adapted to the desired purpose or to the height of an operator.

The extension means is preferably formed as a tube extension, for example in the form of a shaft, which has at least one cavity that can accommodate, for example, a power supply, a control unit and, if necessary, electrical or mechanical cables.

Accordingly, the electrical power supply and, if applicable, the control system in the form of preferably at least one battery, advantageously a rechargeable battery, is arranged preferably in the extension means, optionally removably.

According to a further embodiment, the socket of the connecting portion and/or its guide and/or the plug sockets of the electrical contact points of the connecting portion has/have in each case at least one sealing lip and/or at least one scraper.

The use of such a sealing lip or such a scraper, preferably at the distal entrance of the socket of the connecting portion and/or its guide and/or at the distal entrances of the plug sockets of the electrical contact points of the connecting portion is advantageous in moist and/or dusty environments, since the various sealing lips and/or scrapers, which can be made of rubber or in the form of a miniature brush, for example, offer a certain degree of protection against moisture on the one hand, but can also wipe off any impurities on the plug-in pin and/or the electrical contact plugs of the tool and in this way prevent the corresponding sockets of the connecting portion from becoming contaminated.

Furthermore, the guide of the connecting portion can be formed as a sleeve. Such a sleeve guides the plug-in pin of the tool or the charger or the charging coupling closely and without play when it is inserted into the connecting portion. Such a sleeve is embodied in such a way that it either presses the guide closely against the plug-in pin or fits closely against the plug-in pin and/or the guide, so that the plug-in pin can be pushed into its end position with virtually no, or little or a small amount of play. The sleeve and/or the guide, for this purpose, can be made of a material on which the plug-in pin can slide, for example polytetrafluoroethylene.

Furthermore, according to another embodiment, the sleeve can be substantially annular and can enclose the plug-in pin at its proximal end, so that the guide of the socket in the plugged-in state of the plug-in pin is quasi closed by the sleeve and the plug-in pin is thereby held centrally, namely centred by the sleeve.

Since the sleeve is firmly attached to this end of the plug-in pin, which from the point of view of the particular tool is the proximal end, the plug-in pin is thus held and secured in its locking position by the sleeve not only axially, but also radially. At the same time, the guide is advantageously closed and sealed against the ingress of contaminants, such as dust or moisture, by the sleeve, which is made, for example, of rubber or another energy-elastic material.

The tool is either an electrically operable implement, such as a hedge trimmer, a lawn trimmer, a saw, a pair of shears, in particular pruning shears, or a non-electrical implement, such as a rake, a spade, a broom or a shovel.

In summary, the disclosure consists of combining the handle with the supply battery and reducing the complexity of charging and discharging by using the same interface. Charging and discharging/working is done via the same interface at the same position of the handling device by means of a quick lock or a quick connector.

### BRIEF DESCRIPTION OF DRAWINGS

In the following, the invention is described by means of exemplary embodiments, which are explained in more detail with reference to the figures, in which:

FIG. 1 shows a schematic representation of a handling device with connected charger or connected charging coupling according to an embodiment;

FIG. 2 shows a schematic representation of a handling device with connected tool according to a further embodiment;

FIG. 3 shows a schematic representation of an exemplary embodiment of a handling device;

FIG. 4 shows a sectional view along the line Z-Z of the exemplary embodiment shown in FIG. 3;

FIG. 5 shows an enlarged representation of the area of the handling device enclosed by a circle in FIG. 4;

FIG. 6 shows a schematic representation of a handling device with a charging coupling provided; and

FIG. 7 shows a schematic representation of a charger and charging coupling.

### DETAILED DESCRIPTION OF THE INVENTION

In the following description, the same reference signs are used for identical and similarly acting parts.

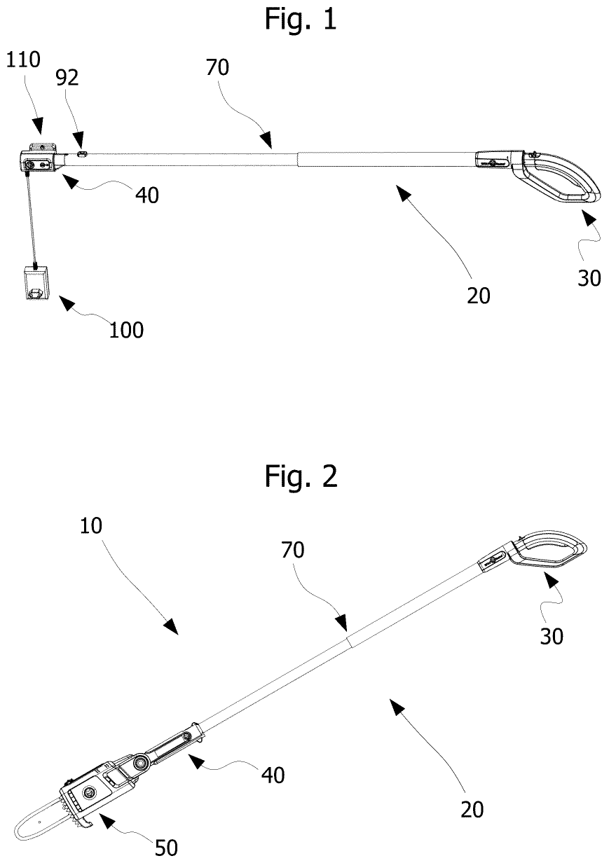

FIG. 1 shows a schematic representation of a handling device 20 with connected charger 100 or connected charging coupling 110 according to an embodiment. The charging coupling 110 is connected to a connecting portion 40 of the handling device 20, the connecting portion 40 being arranged at a distal end of an extension means 70 with respect to a gripping portion 30 of the handling device 20. The charging coupling 110 is connected to the charger 100 via an electrical cable, the charger in turn having plug contacts for connection to a conventional wall socket. To release the charging coupling 110 from the connection portion 40, a release button 92 is further provided to release a plug-in/detent connection arranged in the connection portion 40. Once the detent connection is released, the charging coupling 110 can be removed from the distal end of the handling device 20.

FIG. 2 shows a schematic representation of a processing device 10, specifically a handling device with attached tool, in perspective view. The processing device 10 comprises a handling device 20 with a tool 50 attached thereto. The handling device 20 in turn consists of a handle portion 30, which in turn comprises operating elements such as a safety button and a switching lever, and also a connecting portion 40. The connecting portion 40 is arranged at a distal end of an extension means 70 with respect to the handle portion 30. The connecting portion 40 serves both for the mechanical and the electrical connection of the tool 50 connected to the handling device 20 according to FIG. 2, namely an electrically operated saw.

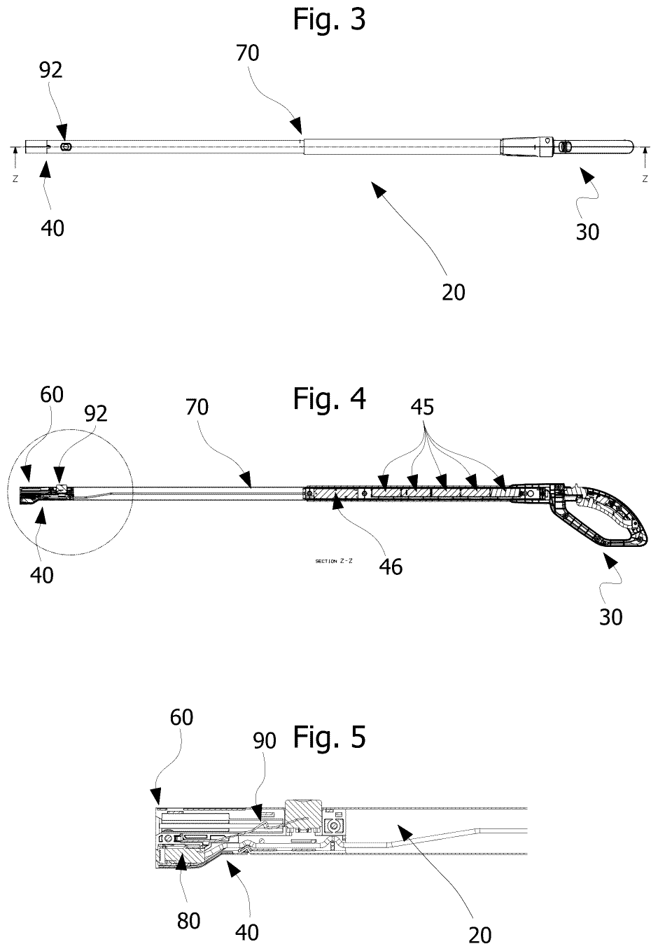

FIG. 3 shows a schematic representation of an embodiment of a handling device 20. The handling device 20 comprises a handle portion 30, on which operating elements of the processing device 10 are arranged. An extension means 70 extends from the handle portion 30 in the direction of the connecting portion 40 and can be extended or shortened telescopically.

FIG. 4 shows a sectional view along the line Z-Z of the exemplary embodiment shown in FIG. 3, wherein it can be seen that a power supply 45 in the form of rechargeable batteries, or accumulators, as well as a control unit 46 for controlling a connected electrical tool are arranged within the extension means 70. As can be further seen in FIG. 4, the connecting portion 40 is formed by a socket 60 which, as shown in more detail in FIG. 5, comprises both an electrical contacting means 80 and a mechanical detent connection 90.

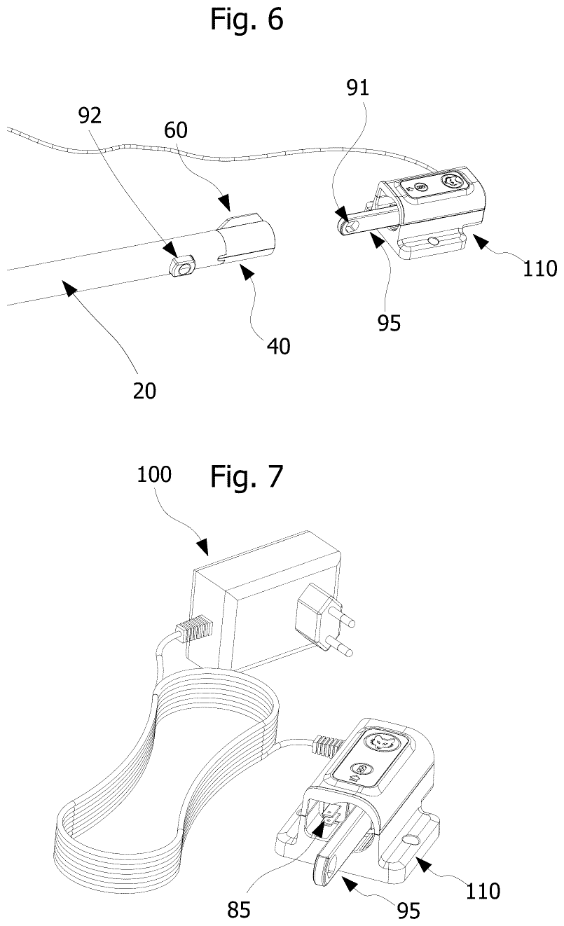

FIG. 6 shows a schematic representation of a handling device 20 with a charging coupling 110 provided. As can be seen in FIG. 6, the handling device 20 has a connecting portion 40, which is formed on the outside by a socket 60. A guide is arranged inside the socket, and a charging pin 95 can be inserted into said guide and locked inside the connecting portion 40. Locking in the connecting portion 40 is effected by means of a detent connection, with a detent projection engaging in a detent recess 91 and in this way preventing unintentional release or removal of the charging pin 95 from the connecting portion 40. A release button 92, which is arranged on the connecting portion 40 so as to be accessible from the outside, can be actuated for deliberate removal of the charging coupling 110. This releases the detent connection holding the charging pin 95 in the connecting portion 40.

FIG. 7 shows a schematic representation of a charger 100 together with a charging coupling 110. The charging coupling 110 is connected by a cable to the charger 100, which in turn can be plugged into an ordinary socket of a household power supply. The charging coupling 110 comprises a charging pin 95, by means of which the charging coupling 110 can be inserted and fixed in a connecting portion 40 of the handling device 20. Furthermore, the charging coupling 110 has two electrical plug-in contacts 85 with which electrical contact can be made by the contact means 80 of the handling device 20, which are arranged in the connecting portion 40 of the handling device 20.

List of reference signs

| | |
|---|---|
| 10 | processing device |
| 20 | handling device |
| 30 | handle portion |
| 40 | connecting portion |
| 45 | power supply |
| 46 | control unit |
| 50 | tool |
| 60 | socket |
| 70 | extension means |
| 80 | electrical contacting/contact means |
| 85 | electrical plug contacts |
| 90 | mechanical snap-fir connection |
| 91 | detent recess |
| 92 | release button |
| 95 | charging/plug-in pin |
| 100 | charger |
| 110 | charging coupling |

We claim:

1. A handling device (20), in particular for a processing device, such as a gardening and/or household device, comprising a gripping portion (30) and an electrical power supply (45) in the form of at least one rechargeable battery, wherein the handling device (20) also comprises contact means (80), which serve alternately, on the one hand, for the electrical connection of a tool (50) to the handling device (20) and, on the other hand, for charging the electrical power supply, in particular by means of a charger (100).

2. The handling device according to claim 1, wherein the contact means (80) are arranged in a connecting portion (40) of the handling device (20) arranged distally with respect to the handle portion (30).

3. The handling device according to claim 1, wherein the connecting portion (40) is formed as a socket (60) and in addition to the contact means (80) further comprises means for mechanically connecting the tool (50) or a charger (100) and/or a charging coupling (110) to the handling device (20) within the socket (60).

4. The handling device according to claim 3, wherein the connecting portion (40) for mechanically connecting the tool (50) to the handling device (20) has detachable form-fit and/or frictional engagement means, for example in the form of a plug-in and/or clamping and/or screw and/or detent and/or snap-fit connection to a, preferably non-circular, guide, in order to insert a plug-in pin of the tool (50) into the connecting portion (40) and to lock it detachably in a locking position, in particular, in an end position.

5. The handling device according to claim 1, wherein the contact means (80) for the electrical connection of the tool (50) or the charger (100) and/or the charging coupling (110) to the handling device (20) has at least two, preferably at least three, electrical contacts, for example in the form of plug sockets, in order to establish electrically conductive contact with corresponding contacts, in particular plugs, of the tool (50) or of the charger (100) and/or of the charging coupling (110).

6. The handing device according to claim 4, wherein the means for mechanical and electrical connection of the tool (50) or the charger (100) and/or the charging coupling (110) to the handling device (20) are arranged relative to one another in such a way that, in a locking position, in particular end position, of the mechanical connection, an electrical connection of the various plug sockets to the corresponding plugs of the tool (50) or the charger (100) and/or the charging coupling (110) assigned to them is ensured.

7. The handling device according to claim 1, wherein the handling device (20) has, between the handle portion (30) and the connecting portion (40), an extension means (70), for example in the form of a tube extension or a shaft, which is in particular telescopic and optionally detachable from the handle portion (30) and/or connecting portion (40).

8. The handling device according to claim 7, wherein the electrical power supply (45) is arranged in the extension means (70), optionally removably.

9. The handling device according to claim 8, wherein the socket (60) and/or the guide and/or the plug sockets has/have in each case at least one sealing lip and/or at least one scraper.

10. The handling device according to claim 9, wherein the guide is in the form of a sleeve which guides and/or holds the plug-in pin of the tool (50) or the charger (100) and/or the charging coupling (110) closely and without play when it is inserted and/or in its locking position in the connecting portion (40).

11. The handling device according to claim 1, wherein the tool (50) is an electrically operable implement, such as a hedge trimmer, a lawn trimmer, a saw, a pair of shears, in particular pruning shears, or a non-electrical implement, such as a rake, a spade, a broom or a shovel.
